(19) United States
(12) Patent Application Publication
(10) Pub. No.: US 2016/0368124 A1
(43) Pub. Date: Dec. 22, 2016

(54) TORQUE INDICATING DRIVER

(71) Applicant: FixT Products, LLC, Broomfield, CO (US)

(72) Inventors: Shane Stamm, Boulder, CO (US); Michael Roswell, Lafayette, CO (US); Dominic Lovely, Denver, CO (US)

(21) Appl. No.: 15/149,861

(22) Filed: May 9, 2016

Related U.S. Application Data
(60) Provisional application No. 62/158,194, filed on May 7, 2015.

(51) Int. Cl. B25B 23/142; B25B 15/02

(52) U.S. Cl. CPC B25B 23/1427; B25B 15/02

(57) ABSTRACT

Embodiments directed to a torque indicating driver and for indicating a value of torque applied by the torque indicating driver. In one aspect, an embodiment for a torque indicating driver including a torsion member with a circular cross section elastically deformable about an axis. The torsion member may be rotationally constrained with respect to tube at a driver proximal end and rotationally constrained with respect to a sleeve disposed in adjacent overlapping relation to the tube at a driver distal end. In this regard, the sleeve may be displaceable with respect to an indicator disposed on the tube such that, commensurate with the application of torque by the torque indicating driver, the displacement may be indicative of a value of torque applied by the torque indicating driver.

### RELATED APPLICATIONS

This application claims benefit of provisional U.S. Application No. 62/158,194 filed on May 7, 2015 entitled “TORQUE INDICATING DRIVER,” the entirety of which is incorporated by reference herein.

### FIELD

The present disclosure relates generally to implements used for indicating a value of torque applied by a driver.

### BACKGROUND

Various mechanical systems may require periodic adjustment of certain structures that may fasten, connect, rotate, or facilitate attachment (collectively “attachment structures”). In some instances, these attachment structures may be configured for rotational adjustment (e.g., screws, nuts, bolts, other fasteners, and the like) such that the attachment structures may be operable to receive an applied torque (i.e., via a force applied perpendicular to the rotational axis of the attachment structure at a point offset from the rotational axis). The applied torque may therefore cause the attachment structure to rotate about a rotational axis of the attachment structure. In turn, this rotation may cause a “tightening” of the attachment structure relative to its respective mechanical system in relation to the corresponding value of the torque applied to the attachment structure.

In this regard, a given attachment structure may be configured to receive an applied torque corresponding to an optimal torque value for appropriate tightening in a given application. In some mechanical systems, receiving an applied torque at an attachment structure that varies from the optimal torque value may be problematic (e.g., contributing to material fatigue, necking, cracking, etc.). In this regard, it is often desirable to measure the value of applied torque at the structural attachment for receiving the applied torque (e.g., to verify the given attachment structure received the optimal value of applied torque).

### SUMMARY

In view of the foregoing, a primary objective of the present disclosure is to provide a torque indicating driver, thereby facilitating the indication of a value of torque applied by the torque indicating driver.

In one aspect, the present disclosure describes embodiments of a torque indicating driver. The torque indicating driver includes a torsion member with a circular cross section elastically deformable about an axis extending between a driver proximal end and a driver distal end. The torque indicating driver further includes a tube disposed in surrounding relation to the torsion member and concentric with the axis to define an annular space between at least a portion of the torsion member and an inner surface of the tube between the driver proximal end and the driver distal end. In this regard, the torsion member may be fixedly attached to the tube at the diver proximal end. The torque indicating driver further includes an indicator disposed on an outer surface of the tube at the driver distal end. The torque indicating driver further includes a sleeve disposed in adjacent overlapping relation with the tube at the driver distal end. In this regard, the torsion member may be fixedly attached to the sleeve at the driver distal end. The sleeve may include an inner surface directly engaged with the outer surface of the tube to define a bearing surface interface between the inner surface of the sleeve and the outer surface of the tube such that the sleeve may be displaceable relative to the indicator. Furthermore, the relative displacement of the sleeve and the indicator may be indicative of an applied torque relative to the corresponding elastic deformation of the torsion member by the applied torque. The torque indicating driver further includes a handle member fixedly attached to the sleeve transverse to the axis to receive the applied torque. The handle member may be operable to displace the sleeve such that the torsion member elastically deforms about the axis.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combinations of the first aspect.

For example, in an embodiment, the torsion member may include an engagement member fixedly attached to the torsion member at the driver proximal end. In this regard, the torsion member may be fixedly attached to the tube at the driver proximal end at the engagement member. In some instances, a pin transverse to the axis fixedly attaches the torsion member to the tube. As such, the engagement member may include a projection portion for selective removable engagement with a structure for receiving the applied torque. The projection portion may include at least one attachment piece for the selective removable engagement of the projection portion with the structure for receiving the applied torque.

In another embodiment, the torsion member may have length of at least 9.2 inches. In other embodiments, the torsion member may have length of less than 9.2 inches. The cross section of the torsion member may have a cross-dimensional area of at least 0.038 square inches. In other embodiments, the torsion member may have a cross-dimensional area of less than 0.038 square inches. In this regard, the torsion member may have a modulus of rigidity of at least 11.0×10³ kilo pounds per square inch. In other embodiments, the torsion member may have a modulus of rigidity of less than 11.0×10³ kilo pounds per square inch.

According to another embodiment, the indicator may include a raised shell disposed in surrounding relation to the tube. As such, the sleeve may be disposed in adjacent contactable relation with the raised shell. In this regard, the indicator may include an incremental scale with a first plurality of increments. The first plurality of increments may correspond to a torque value indicative of the applied torque. Additionally, the incremental scale may include a second plurality of increments. In this regard, the second plurality of increments may correspond to a value indicative of the applied torque and may be disposed at the indicator 120 degrees from said first plurality of increments. Accordingly, the relative displacement of the sleeve and the indicator may correspond to the plurality of increments such that each increment of the plurality of increments may indicate that the applied torque relative to the corresponding elastic deformation of the torsion member by the applied torque. In some cases, the incremental scale may include a range from 4 to 20 foot-pounds.

In yet another embodiment, the sleeve may include an aperture concentric with the axis for receiving the torsion member for the fixed attachment of the torsion member at the driver distal end. In this regard, the sleeve may include an arcuate portion for receiving the handle member. As such, the handle member may be fixedly attached to the sleeve at the arcuate portion via at least one attachment element.

In this regard, a second aspect of the present disclosure includes a method for indicating an applied torque. The method includes selectively engaging a torsion member with a structure for receiving an applied torque at a torque driver proximal end. The torsion member may include a circular cross section elastically deformable about an axis extending between the torque driver proximal end and a torque driver distal end. In this regard, the torsion member may be fixedly attached to a tube at the torque driver proximal end, and the tube may be disposed in surrounding relation to the torsion member concentric with the axis to define an annular space between at least a portion of the torsion member and an inner surface of the tube between the torque driver proximal end and the torque driver distal end. The method further includes receiving an applied torque at the torsion member via a handle member fixedly attached to a sleeve transverse to the axis such that the sleeve may be displaced relative to an indicator disposed on an outer surface of the tube at the torque driver distal end. Notably, the relative displacement of the sleeve and the indicator may be indicative of the applied torque relative to the corresponding elastic deformation of the torsion member by the applied torque. In this regard, the sleeve may be disposed in adjacent overlapping relation with the tube at the torque driver distal end, and the sleeve may include an inner surface directly engaged with an outer surface of the tube to define a bearing surface interface between the inner surface of the sleeve and the outer surface of the tube. The method further includes indicating a torque value at the indicator of the applied torque at least partially based on the relative displacement of the sleeve and the indicator.

A number of feature refinements and additional features are applicable in the second aspect and contemplated in light of the present disclosure. These feature refinements and additional features may be used individually or in any combination. As such, each of the following feature combinations that will be discussed may be, but are not required to be, used with any other feature combinations of the second aspect.

For example, in an embodiment, the indicator may include an incremental scale with a plurality of increments such that each increment of the plurality of increments may correspond to the torque value of the applied torque. Further, the relative displacement of the sleeve and the indicator may correspond to the plurality of increments such that each increment of the plurality of increments may indicate the applied torque relative to the corresponding elastic deformation of the torsion member by said applied torque. In some instances, the incremental scale may have a range from 4 to 20 foot-pounds.

### BRIEF DESCRIPTION OF THE DRAWINGS

FIG. 1 depicts an embodiment of a torque indicating driver in a system including a structure for receiving a torque applied by said torque indicating driver.

FIG. 2 is an expanded assembly view of an embodiment of a torque indicating driver.

FIG. 3 is a cross-sectional view of an embodiment of an assembled torque indicating driver.

FIG. 4A is an isometric view of an embodiment of a torsion member of a torque indicating driver.

FIG. 4B is an enlarged isometric view of an embodiment of an engagement member of a torsion member.

FIG. 5 is an isometric view of an embodiment of a tube of a torque indicating driver.

FIG. 6A is an isometric view of an embodiment of an indicator of a torque indicating driver.

FIG. 6B is an isometric view of another embodiment of an indicator of a torque indicating driver.

FIG. 7A is an isometric view of an embodiment of a sleeve of a torque indicating driver.

FIG. 7B is a top view of an embodiment of a sleeve of a torque indicating driver.

FIG. 7C is a left view of an embodiment of a sleeve of a torque indicating driver of FIG. 2.

FIG. 8 is an isometric view of an embodiment of a handle member of a torque indicating driver.

FIG. 9 illustrates with a flow diagram an embodiment of a method for indicating an applied torque.

### DETAILED DESCRIPTION

Disclosed herein are embodiments related to a torque indicating driver and for indicating a value of torque applied by the torque indicating driver. The disclosed embodiment may employ a torsion member elastically deformable about an axis extending between a driver proximal end (e.g., adjacent to a structure for receiving torque applied by the torque indicating driver) and a driver distal end (e.g., opposite the driver proximal end). The torsion member may be rotationally constrained (e.g., via a pin, screw, interference fit, or the like) with respect to a tube at the driver proximal end and rotationally constrained (e.g., via a pin, screw, interference fit, or the like) with respect to a sleeve disposed in adjacent overlapping relation to the tube at the driver distal end (e.g., to define a bearing surface interface between an inner surface of the sleeve and an outer surface of the tube). Notably, the sleeve may receive a torque via a handle member fixedly attached to the sleeve (e.g., by the application of force at the handle member for induced displacement of the sleeve) such that the sleeve is displaceable relative to an indicator disposed on the tube in response to the application of the torque to the structure by the torque indicating driver. In this regard, the displacement of the sleeve relative to the indicator may be indicative of the value of a torque applied by the torque indicating driver, as may be measured relative to the corresponding elastic deformation of the torsion member.

Reference will now be made to the accompanying drawings, which assist in illustrating the various pertinent features of the various novel aspects of the present disclosure. The following description is presented for purposes of illustration and description. Furthermore, the invention is not intended to limit the inventive aspects to the forms disclosed herein. Consequently, variations and modifications commensurate with the following teachings, and skill and knowledge of the relevant art, are within the scope of the present inventive aspects.

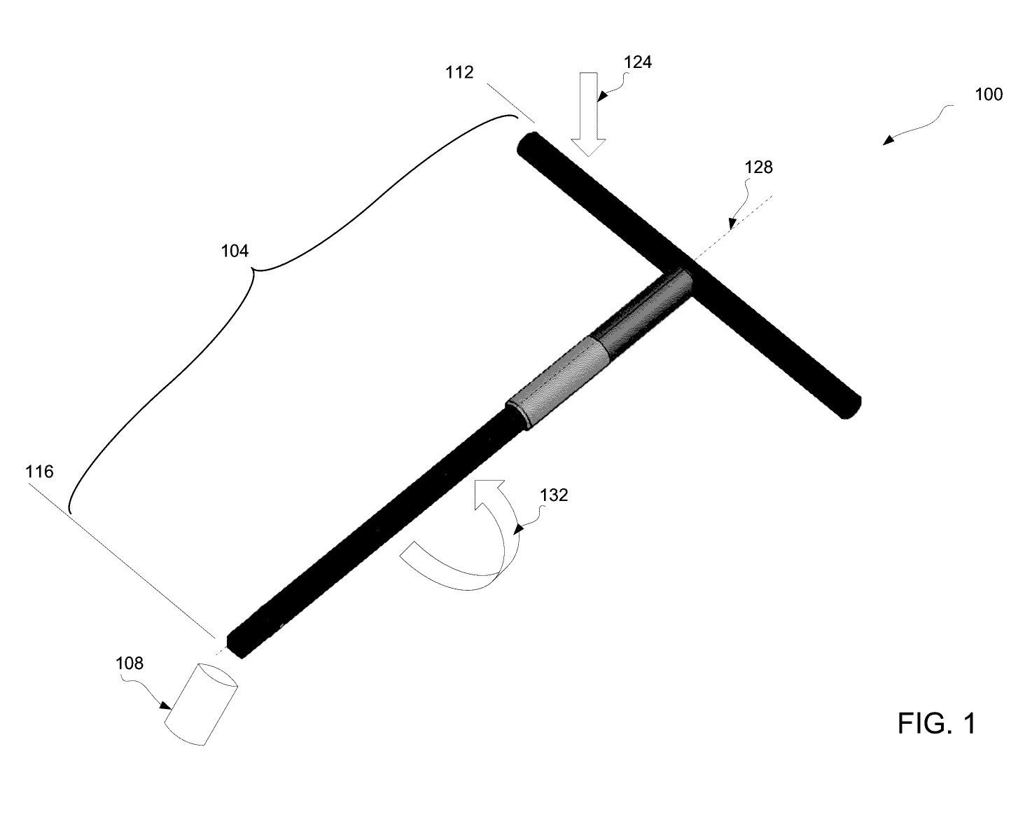

In this regard, FIG. 1 presents an embodiment of a system 100 of a torque indicating driver 104 for indicating a value of torque applied to receiving structure 108. Broadly, the torque indicating driver 104 may be used in a system 100 for indicating a value of torque applied to a receiving structure 108 (e.g., screws, nuts, bolts, fasteners, other fasteners, and the like). In this regard, the torque indicating driver 104 may receive a torque at the driver distal end 112 for application by the torque indicating driver 104 at the receiving structure 108 at the driver proximal end 116. According to one embodiment, the torque indicating driver 104 may receive the torque via handle member 120. For example, a force 124 applied to the handle member 120 at a vector transverse to and offset from an axis 128 may result in a torque 132 about the axis 128 for application at the receiving structure 108. The axis 128 may extend between the driver proximal end 116 and the driver distal end 112. In this regard, and as discussed in greater detail below, a torsion member may be elastically deformable about the axis 128 to facilitate the application of torque 132 at the receiving structure 128 and to facilitate the indication of the value of applied torque 132 in part by reference to the corresponding elastic deformation of the torsion member (i.e., the torque applied by the torque indicating driver 104 may be indicated as a function of the elastic deformation of the torsion member).

In this regard, torque 132 may be transmitted through the torque indicating driver 104 for application to the receiving structure 128. Commensurate with the transmission of the torque 132, the torsion member is deflected. As the torsion member is rotationally constrained with respect to the tube and sleeve, respectively, with application of the torque 132, the torsion member may flex, thus resulting in rotational displacement between the tube and the sleeve. The amount of deflection may be dependent on the modulus of elasticity, shear module, or other properties of the torsion member. In any regard, the amount of deflection in relation to an applied torque may be measured such that a calibrated scale (e.g., an incremental scale) may be provided in relation to the tube and the sleeve. In turn, the calibrated scale may provide an indication of a value of the torque applied by the torque indicating driver 104.

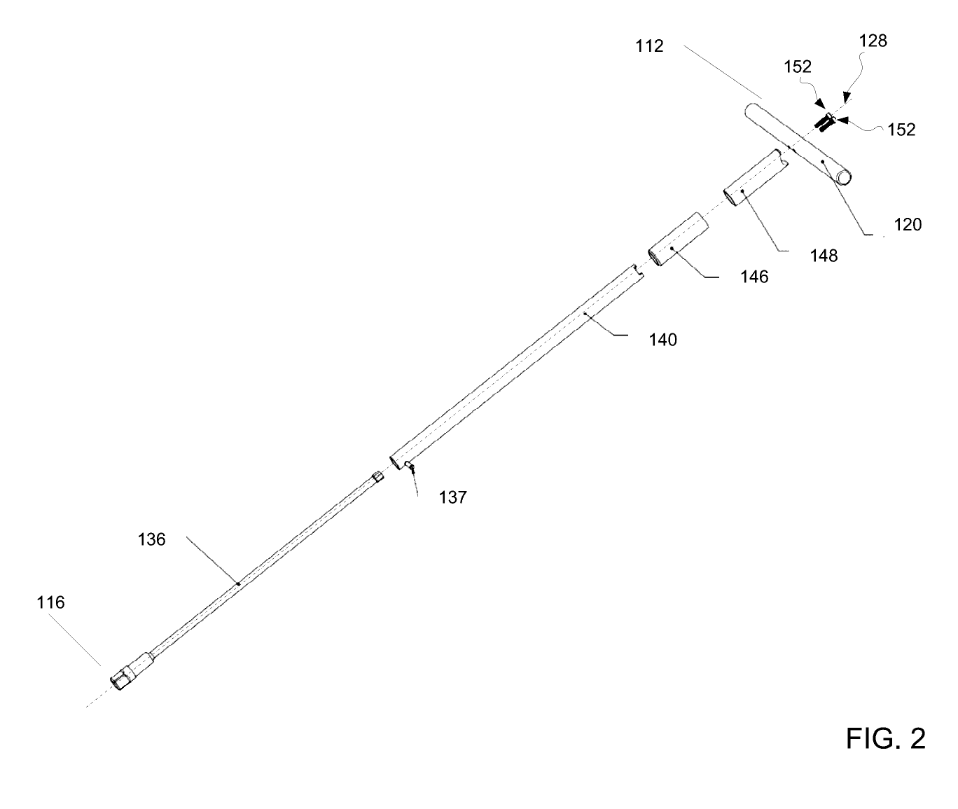

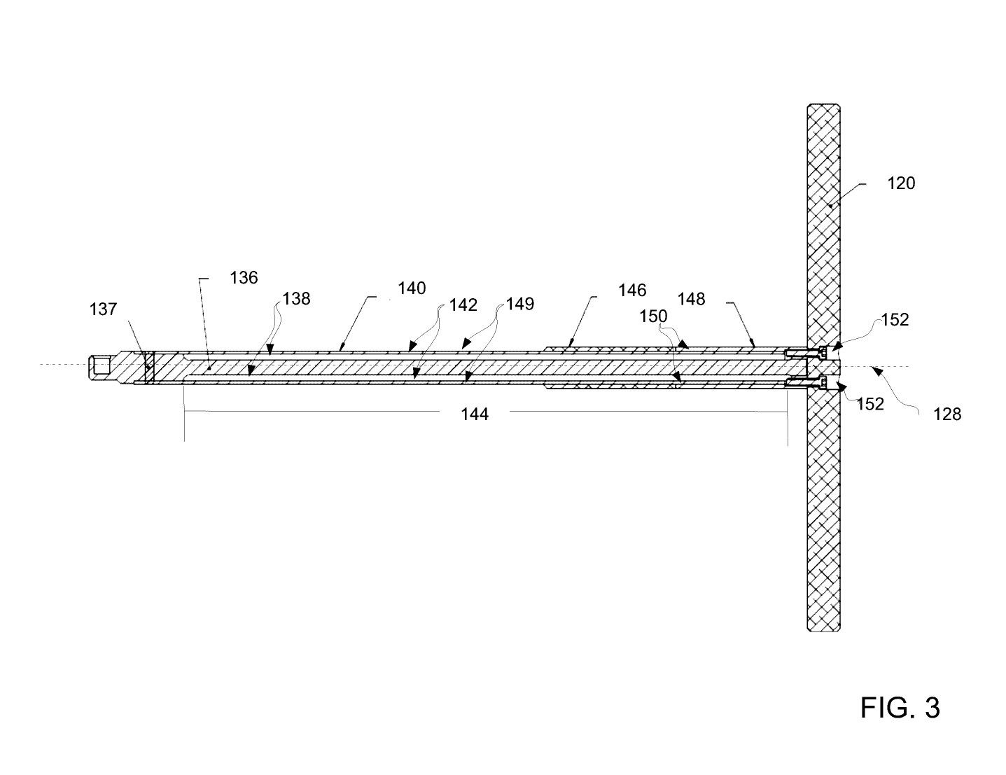

Turning next to FIGS. 2 and 3, the torque indicating driver 104 may include a torsion member 136 elastically deformable about the axis 128. The torsion member 136 may be of any appropriate configuration to facilitate elastic deformation about axis 128. In this regard, the torsion member 136, discussed in greater detail below, may be of sufficient size shape, shape, and material such that torsion member 136 rotates about the axis 128 in manner that facilitates indication of a value of a torque applied by torque indicating driver 104 (e.g., torque 132). A tube 140 may be disposed in surrounding relation to the torsion member 136 and concentric with the axis 128 to define an annular space 138 between at least a portion of the torsion member 136 and an inner surface 142 of the tube 140 between the driver proximal end 116 and the driver distal end 112. In this regard, the torsion member 136 may elastically deform about the axis 128 over a length 144 of the annular space 138 disposed within the tube 140. The torsion member 136 may be provided in rotationally constrained relation (e.g., fixedly attached) to the tube 140 at the driver proximal end 116, for example, via a pin 137 extending through the tube 140 and the torsion member 136. In other embodiments, the torsion member 136 may be fixedly attached to the tube 140 via a screw, weld, interference fit, or the like.

The torque indicating driver 104 may also include an indicator 146 disposed on a tube outer surface 149 at the driver distal end 112. The indicator 146, discussed in greater detail below, may be operable to indicate a value of torque applied by the torque indicating driver 104 at least partially based on the degree of elastic deformation of the torsion member 136 (e.g., as measured by an angle of twist θ, etc.) about the axis 128 produced by the application of the torque. The torque indicating driver 104 may also include a sleeve 148 disposed in adjacent overlapping relation with the tube 140 at the driver distal end 112 to define a bearing surface interface 150 between a sleeve inner surface 174 and the tube outer surface 149. In this regard, the sleeve inner surface 174 may by directly engaged with, and displaceable over, the tube outer surface 149. Accordingly, the sleeve 148 may be displaceable relative to the indicator 146. In this regard, the torsion member 136 may be fixedly attached to the sleeve 148 at the driver distal end 112 such that the displacement of the sleeve 148 relative to the indicator 146 may be indicative of a torque applied by the torque indicating driver 104 (i.e., the displacement may correspond to the elastic deformation of the torsion member 136 produced by the applied torque). For example, torque applied at the sleeve 148 (i.e., about the axis 128) may induce the displacement of the sleeve 148 relative to the indicator 146 by a distance corresponding to the elastic deformation of the torsion member 136 produced by the torque (i.e., the torque at the sleeve is proportional to the angular displacement (angle of twist θ) of the torsion member 136).

The torque indicating driver 104 may also include a handle member 120 fixedly attached to the sleeve 148 transverse to the axis 128. In this regard, the sleeve 148 may receive a torque for application by the torque indicating driver 104 via the fixedly connected handle member 120. That is, the handle member 120 may facilitate receiving a torque for application by the torque indicating driver 104 by accepting a force acting at a point on the handle member 120 offset from and transverse to the axis 128. In some embodiments, the handle member 120 may be fixedly attached to the sleeve 148 via at least one attachment element (e.g., screws 152).

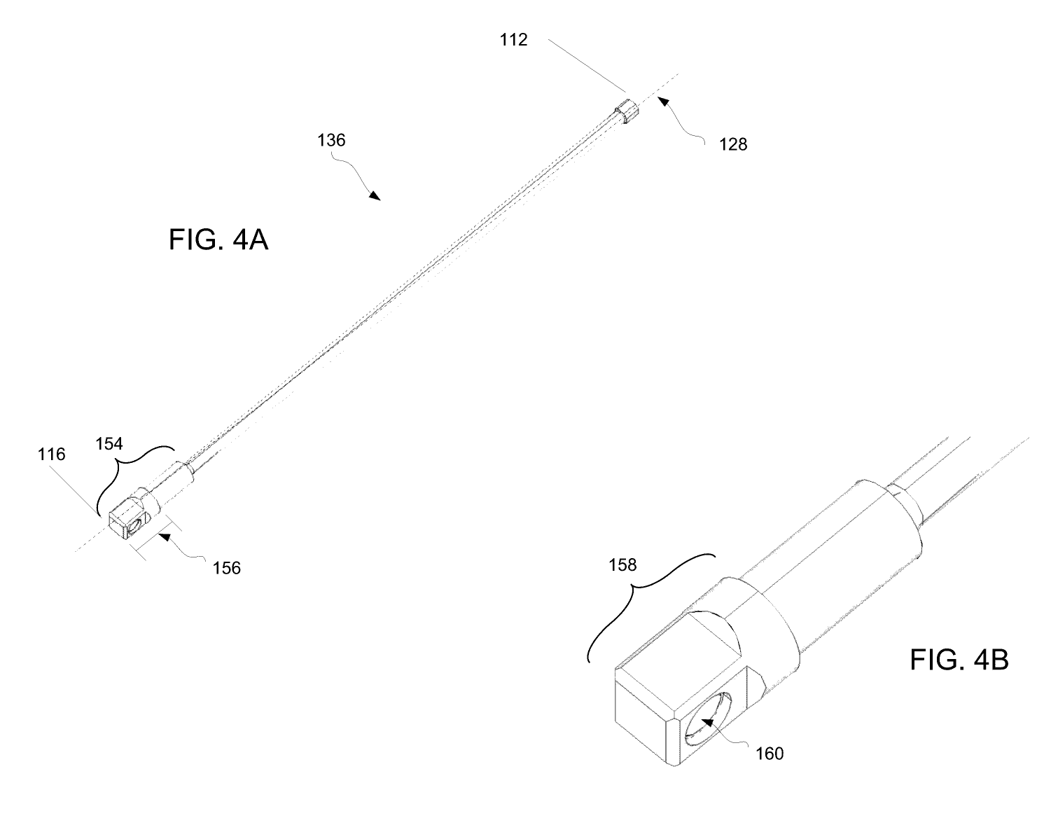

Turning next to FIG. 4A, an isometric view of the torsion member 136 is depicted. The torsion member 136 may include an engagement member 154 at the driver proximal end 116. The engagement member 154 may facilitate the rotationally constrained relation of the torsion member 136 to the tube 140. For example, the torsion member 136 may be fixedly attached to the tube 140 at the engagement member 154. According to one embodiment, the pin 137 may fixedly attach the torsion member 136 to the tube 140 at the engagement member 154 at the driver proximal end 116. The tube 140 may be disposed in surrounding relation to at least a portion of the engagement member 154. Correspondingly, at least a portion of the engagement member 154 may extend a distance 156 beyond the tube 140 at the driver proximal end 116.

Accordingly, the engagement member 154 may also facilitate the selective removable engagement of the torque indicating driver 104 with a structure for receiving (e.g., receiving structure 108) an applied torque (e.g., applied torque 132). In this regard, the engagement member 154 may include a projection portion 158 for the selective removable engagement of the torque indicating driver 104 with a structure for receiving the applied torque. The projection portion 158 may substantially extend the length 156 at the driver proximal end 116.

Notably, the projection portion 158 may be of any shape and configuration to facilitate the selective removable engagement with the structure for receiving an applied torque. For example, according to one embodiment, the projection portion 158 may include a rectangular cross-section with chamfered edges for insertion into a structure for receiving an applied torque such that the structure for receiving the applied torque is disposed in surrounding relation to the projection portion 158 (e.g., the projection portion 158 may include a male member received by a female member of the structure for receiving an applied torque). The projection portion 158 may engage another interchangeable piece (e.g., a socket of various adaptable sizes and configurations, etc.) for application of torque to a corresponding fastener or the like. In other embodiments, the projection portion 158 may be operable to receive a structure for receiving an applied torque such that the projection portion 158 is disposed in surrounding relation with the structure for receiving the applied torque (e.g., projection portion 158 may include a female member for receiving a male member of the structure for receiving an applied torque).

In yet other embodiments, the projection portion 158 may include at least one attachment piece 160 for the selective removable engagement of the projection portion 158 with a structure for receiving an applied torque. In this regard, the at least one attachment piece 160 may removably secure the torque indicating driver 104 with a structure for receiving the applied torque (e.g., by preventing rotational slipping, axially sliding, and the like). In some embodiments, the attachment piece 160 may include a female member (as depicted in FIGS. 4A and 4B) for receiving a corresponding attachment piece of a structure for receiving an applied torque (e.g., the attachment piece 160 may include a semi-hemispherical recess). In other embodiments, the attachment piece 160 may include a male member for removable insertion with a corresponding attachment piece of a receiving structure for receiving an applied torque (e.g., the attachment piece 160 may include a semi-hemispherical projection). In some instances, the semi-hemispherical projection may be retractable into the projection portion 158 (e.g., to facilitate the insertion of projection portion 158 with a structure for receiving an applied torque, etc.).

The torsion member 136 may be of any appropriate configuration to facilitate the elastic deformation about axis. In this regard, according to one embodiment, the torsion member 136 may be of a substantially circular cross-section between at least a portion of the driver proximal end 116 and the driver distal end 112. It will be appreciated, however, that the torsion member 136 may include other cross-sectional geometries, including rectangular, square, triangular, and the like. As discussed in greater detail below, the geometric properties (e.g., cross-section, length, etc.) of the torsion member 136 may be configured in relation to an operable measurable range of the torque applied by the torque indicating driver 104 for generation of a calibrated scale. For the sake of a non-limiting illustration, the torque indicating driver 104 may indicate a value of an applied torque in the range of not less than about 4 FT-LB and not more than about 20 FT-LB, and may include a torsion member 136 with a cross-sectional area of at least 0.038 square inches, and a length of at least 9.2 inches. In other embodiments, the torque indicating driver 104 may be configured to indicate a value of applied torque less than 4 FT-LB or greater than 20 FT-LB. For example, the geometric properties (e.g., cross-sectional area, length, etc.) of the torsion member 136 may be modified or scaled in any appropriate manner to facilitate the indication of a value of an applied torque according to a desired range of torque values (i.e., the range of applied torque values may be customized by corresponding modification of the geometric properties of the torsion member 136).

Notably, however, the operable measurable range of torsion member 136 may be configured according to various mechanical (e.g., geometric, etc.) and material properties. That is, the torsion member 136 may elastically deform about axis 128 as a function of the torque applied by the torque indicating driver 104 in relation to the various mechanical and material properties. In particular, the torsion member 136 may be elastically deformable about the axis 128 according generally to the equation for the calculation of torque of a shaft with a uniform cross-section, which is provided below:

T=(J_{T/l})Gθ

wherein T=the applied torque,

J_{T}=the torsion constant,

l=the length of the object,

G=the shear modulus, and

θ=the angle of twist.

In this regard, torsion member 136 may be constructed to facilitate the indication of a torque applied by torque indicating driver 104 by configuring the torsion member 136 relative to a desired operable measurement range. In particular, and as discussed in greater detail below, the indicator 146 may be operable to indicate a value of torque at least partially based on the degree of elastic deformation of torsion member 136 about axis 128 attributable to the torque (i.e., as torsion constant J_{T}, length l, and shear modulus G may be constant for a particular torque indicating driver 104, the torque T may be determined by reference to the angle of twist θ). In this regard, the elastic deformation may be measured as a function of the displacement (e.g., rotational displacement, etc.) of torsion member 136 about the axis 128. The rotational displacement of the torsion member 136 may be modeled in the foregoing equation by the variable angle of twist 0. Accordingly, as the applied torque T may be proportional to θ as a function of (J_{T}/l)G, the torque indicating driver 104 may be operable to measure angle of twist 0 to facilitate the indication of the value of the applied torque T

In this regard, angle of twist 0 may increase as the applied torque T increases (i.e., where the expression “(J_{T}/l)G” remains constant). Torsion constant JT, by definition, includes a constant value indicative of the cross-sectional dimensions of the torsion member 136 (i.e., torsion constant J_{T} may be a different constant value for each particular, uniform cross-sectional geometry). The shear modulus G (or modulus of rigidity) defined as a ratio of shear stress to shear strain in a given material may also be constant for a given material at a given temperature. The length l may be constant as well (i.e., the applied torque may be indicated by reference to the same length at the torsion member 136 in each instance). In this regard, the torque indicating driver 140 may indicate a value of a torque applied by torque indicating driver 104 in relation to the angle of twist θ of the torsion member 136. As such, the mechanical and material properties of torsion member 136 may be configured such that the angle of twist θ corresponding to a particular operable measurement range of the torque indicating driver 104.

In this regard, the mechanical and material properties of the torsion member 136 may be configured to a particular operable measurement range for the angle of twist θ (e.g., in order to increase the precision of the measurement) according to various embodiments. For example, a torsion member 136 with a longer indication length l may produce a greater operable measurement range for the angle of twist θ as compared to a torsion member 136 with a shorter indication length l. Correspondingly, a torsion member 136 with a higher torsion constant J_{T} (e.g., indicative of a more rigid geometry) or higher shear modulus G (e.g., indicative of a more rigid material) may produce a lesser operable measurement range for the angle of twist θ as compared to a torsion member 136 with a lesser torsion constant J_{T} or a lesser shear module G. In this regard, according to another non-limiting example, the torsion member 136 may have a modulus of rigidity of at least 11.0×10³ kilo pounds per square inch. In other embodiments, the torsion member 136 may have a modulus of rigidity of less than 11.0×10³ kilo pounds per square inch. Accordingly, the torsion member 136 may include any appropriate material configurable to the foregoing mechanical and material properties, including stainless steel and the like. According to one embodiment, torsion member 136 may include 17-7 PH condition A stainless steel (according to ASTM A 693 or AMS 5604).

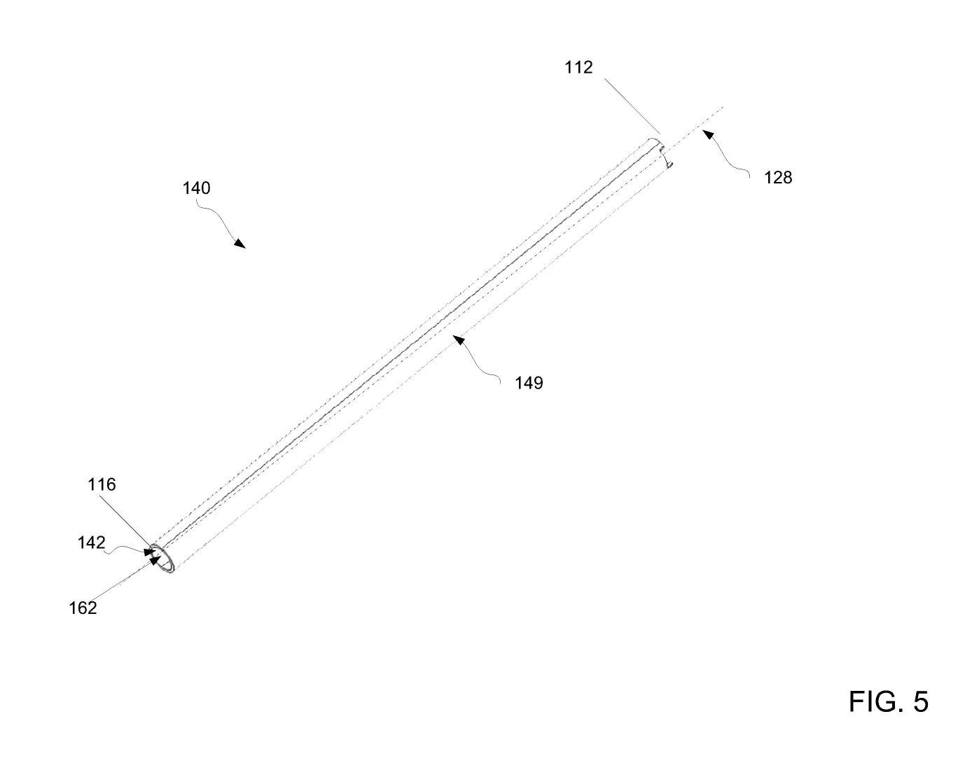

Turning next to FIG. 5, an isometric view of the tube 140 is depicted. The tube 140 may extend between driver proximal end 116 and driver distal end 112 along the axis 128 over a substantially tubular shape. In this regard, the tube 140 may include a tube inner surface 142 and a tube outer surface 149 to define a cylindrical opening 162 extending the length of the tubular shape. The cylindrical opening 162 may be of sufficient area to facilitate the disposition of the tube 140 in surrounding relation to the torsion member 136. In particular, the cylindrical opening 162 may receive the torsion member 136 at the driver proximal end 116 such that the torsion member 136 is disposed concentric with the axis 128 to define an annular space 138 between at least a portion of the torsion member 136 and the tube inner surface 142 between the driver proximal end 116 and the driver distal end 112.

Additionally, the cylindrical opening 162 may facilitate the rotationally constrained relation of the torsion member 136 to the tube 140 at the driver proximal end 116 (e.g., via pin 137, etc.). According to one embodiment, the tube 140 may be disposed in adjacent surrounding relation to the torsion member 136 at the driver proximal end 116 (i.e., such that engagement member 154 and the inner surface 142 are contactably engaged). In this regard, the tube 140 may be disposed in surrounding relation to the torsion member 136 such that at least a portion of the torsion member 136 (e.g., engagement member 154) is disposed adjacent to the tube inner surface 142 and that at least a portion of torsion member 136 (e.g., the elastically deformable cross-section along length 144, etc.) is disposed concentric with the axis 128 to define the annular space 138 within the tube 140.

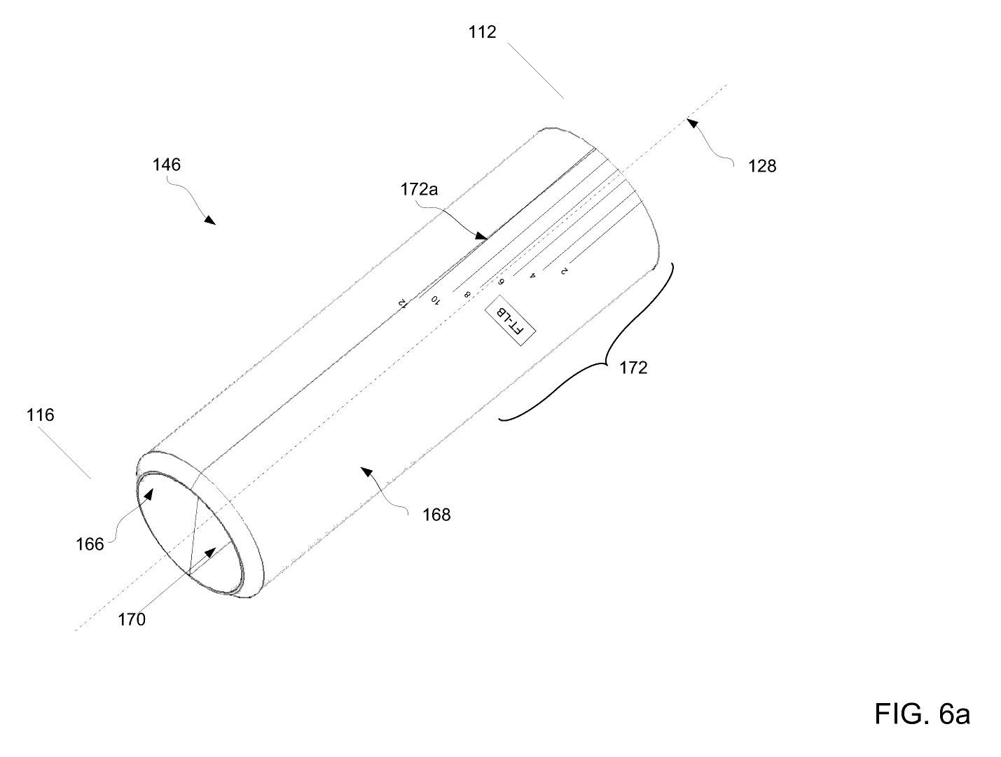

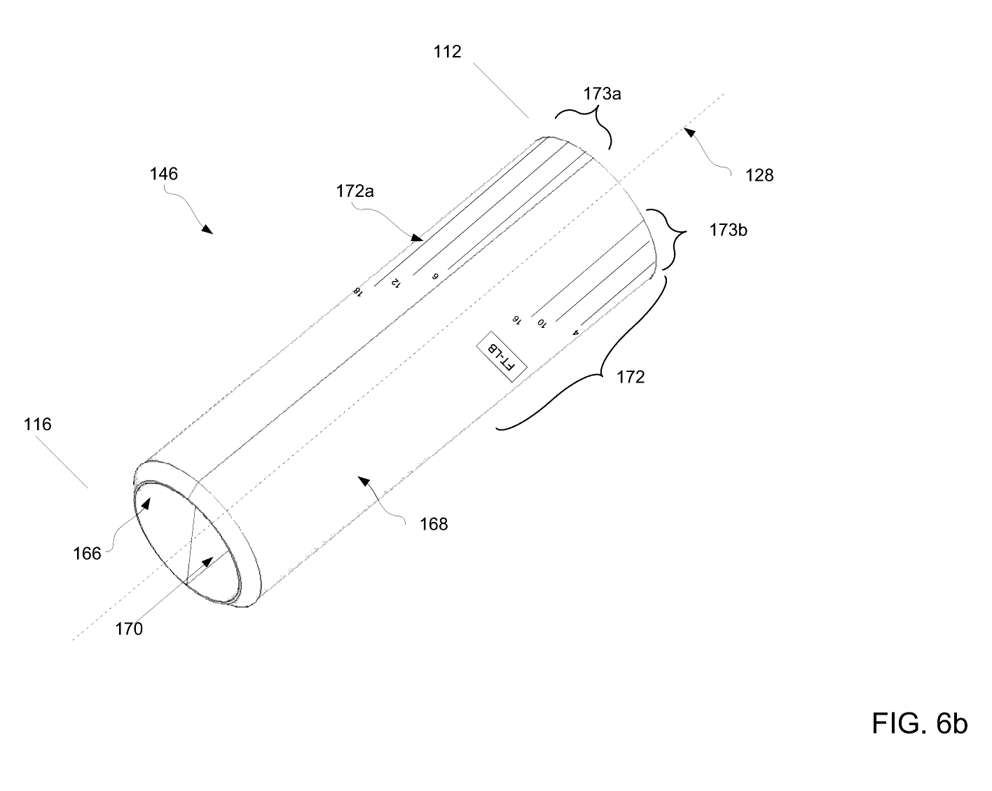

Turning next to FIG. 6A, an isometric view of indicator 146 is depicted. According to one embodiment, indicator 146 may include a substantially tubular shape (e.g., a raised shell) for disposition onto the tube outer surface 149 (e.g., for surrounding overlapping disposition of the indicator 146 onto the tube 140). In this regard, the indicator 146 may include an indicator inner surface 166 and an indicator outer surface 168 defining an indicator cylindrical opening 170 spanning the length of the indicator 146. Notably, however, the indicator 146 is presented as a tubular shape for purposes of illustration only. The indicator 146 may be of any appropriate construction for disposition onto the tube 140 such that the indicator 146, as discussed in greater detail below, may be operable to provide an indication of the displacement of the sleeve 148 relative to the tube 140 (e.g., corresponding to the elastic deformation of the torsion member 136). In some contemplated embodiments, the indicator 146 may be integrally formed with the tube 140. In another embodiment, the indicator 146 may include marking provided directly on the tube 140.

The indicator 146 may be disposed generally at driver distal end 112 at a fixed distance l (i.e., length l as represented in the expression: “T=(J_{T}/l)G0”) from the engagement member. In this regard, the indicator 146 may be calibrated to indicate a value of the torque applied by the torque indicating driver 104 by reference to the measured displacement of the sleeve 148 relative to the tube 140 (i.e., indicative of the elastic deformation of the torsion member 136) with respect to the particular length l (i.e., the length l at which the indicator is disposed on the tube 140) of the torsion member 136. In this regard, the sleeve 148 may be disposed in adjacent contactable relation with the indicator 146 at driver distal end 112. Accordingly, just as the sleeve 148 is displaceable relative to the tube 140, so, too, is the sleeve 148 displaceable relative to the indicator 146. In this regard, the indicator 146 may facilitate indication of a value of torque applied by torque indicating driver 104 by providing a visual indication of the measured displacement of the sleeve 148 relative to the indicator 146.

In this regard, the indicator 146 may include an incremental scale 172 (i.e., a calibrated scale) to facilitate the indication of the value of torque applied by torque indicating driver 104 by reference to visual indicators (e.g., 172a) incrementally disposed on the indicator outer surface 168 (i.e., corresponding to the operable measurement range of the torque indicating driver 104). The incremental scale 172 may be disposed to a given θ as described below. In this regard, each of the visual indicators may correspond to a torque value (e.g., 12 FT-LB as in the case of visual indicator 172a). In particular, the visual indicators may be circumferentially disposed about the indicator 146 to correspondingly measure the angle of twist θ of torsion member 136 as it elastically deforms about axis 128. Accordingly, incremental scale 172 may indicate a torque value as a function of the displacement (e.g., angle of twist θ) of sleeve 148 (fixedly attached to the torsion member 136) relative to the indicator 146 (e.g., according to the equation: T=(J_{T}/l)Gθ). That is, as the torque applied by torsion member 104 increases, so, too, does the displacement of the sleeve 148 (e.g., as measured by the angle of twist θ) relative to the indicator 146 also increase. As such, the incremental scale 172 may include any appropriate visual indicators associated with torque values disposed corresponding to the torque values associated with the displacement of the sleeve 148 relative to the indicator 146 (i.e., each visual indicator may be circumferentially disposed relative to angle of twist θ of the torsion member 136 that corresponds to an angle of twist θ of the torsion member 136 for a particular torque applied by torque indicating driver 104).

Turning next to FIG. 6B, according to another embodiment, the indicator 146 may include an incremental scale 172 with at least a first plurality of increments 173a and a second plurality of increments 173b. Each of the first plurality of increments 173a and the second plurality of increments 173b may correspond to a value indicative of the applied torque (e.g., to facilitate the indication of a value of torque applied by the torque indicating driver 104). The first plurality of increments 173a and the second plurality of increments 173b may be disposed circumferentially at the indicator 146 such that the first plurality of increments 173a and the second plurality of increments 174b may be separated by an angular distance in relation to the geometry of the indicator 146. For example, according to one embodiment, the first plurality of increments 173a and the second plurality of increments 173b may be separated by an angular distance of 120 degrees (i.e., the second plurality of increments 173b may be disposed, for example, at a point on the circumference of the indicator 146 that is separated by 120 degrees from a point at which the first plurality of increments 173a is disposed).

Accordingly, the circumferentially spaced disposition of the first plurality of increments 173a and the second plurality of increments 173b may facilitate the indication of a value of torque, for example, by enhancing the visibility of the visual indicators 172a. That is, as each of the first plurality of increments 173a and the second plurality of increments 173b may correspond to different values of torque, the relative spacing of the visual indicators may be modified according to the various different values of torque for the first plurality of increments 173a and the second plurality of increments 173b. For example, the first plurality of increments 173a may include visual indicators corresponding to 4, 10, and 16 FT-LB of torque and the second plurality of increments 173b may include visual indicators corresponding to 6, 12, and 18 FT-LB of torque. In this regard, the incremental scale 172 may indicate a torque value as a function of the displacement of sleeve 148 with respect to each of the first plurality of increments 173a and the second plurality of increments 173b. That is, according to above example, the visual indicators corresponding to 4, 10, and 16 FT-LB of torque, respectively, of the first plurality of increments 173a may indicate a value of applied torque according to the displacement of the sleeve 148 relative to the first plurality of increments 173a. Analogously, the visual indicators corresponding to 6, 12, and 18 FT-LB of torque, respectively, of the second plurality of increments 173b may indicate a value of applied torque according to the displacement of the sleeve 148 relative to the second plurality of increments 173b. As such, the density of the visual indicators associated with each of the first plurality of increments 173a and the second plurality of increments 173b may be reduced or otherwise modified in relation to an incremental scale with a single plurality of increments (i.e., the totality of visual indicators corresponding to the operable measureable range of the torsion member 136 may be distributed between the first plurality of increments 173a and the second plurality of increments 173b, thereby reducing the amount of visual indicators in each plurality). In other embodiments, the incremental scale 172 may include additional pluralities of increments configured in various patterns to facilitate the indicator of a value of applied torque (e.g. a third plurality of increments disposed at the indicator 146 by an angular distance of 120 degree from the second plurality of increments 173b).

As previously discussed, the torque applied by the torque indicating driver 104 may be measured as a function of the angle of twist θ according generally to the equation: T=(J_{T}/l)Gθ. In this regard, the torque indicating driver 104 may be operable to indicate a torque value according to various operable measurement ranges at least partially based on the mechanical (e.g., geometric) and material properties of the torsion member 136. For example, in one embodiment, the incremental scale 172 may include a range of from 2 to 20 foot-pounds. In this regard, the incremental scale 172 may include visual indicators 172a circumferentially disposed to correspond to torque values by increments of 2 foot-pounds (i.e., the visual indicators may be circumferentially disposed such that each subsequent disposition of the visual indicator may be equivalent to an angle of twist θ of torsion member 136 that corresponds with a torque applied by torsion member 136 of approximately 2 foot-pounds). Other embodiments are contemplated where the torque indicating driver 104 is operable to indicate a value of torque, including indicating a value of torque in a range less than 2 FT-LB, greater than 20 FT-LB, or in any other combination therein. Moreover, incremental scale 172 may dispose the visual indicators (e.g., 172a) in any appropriate manner. For example, the visual indicators may be disposed to correspond to torque values by increments of 1 foot-pounds, 4 foot-pounds, or other appropriate increments embodied herein.

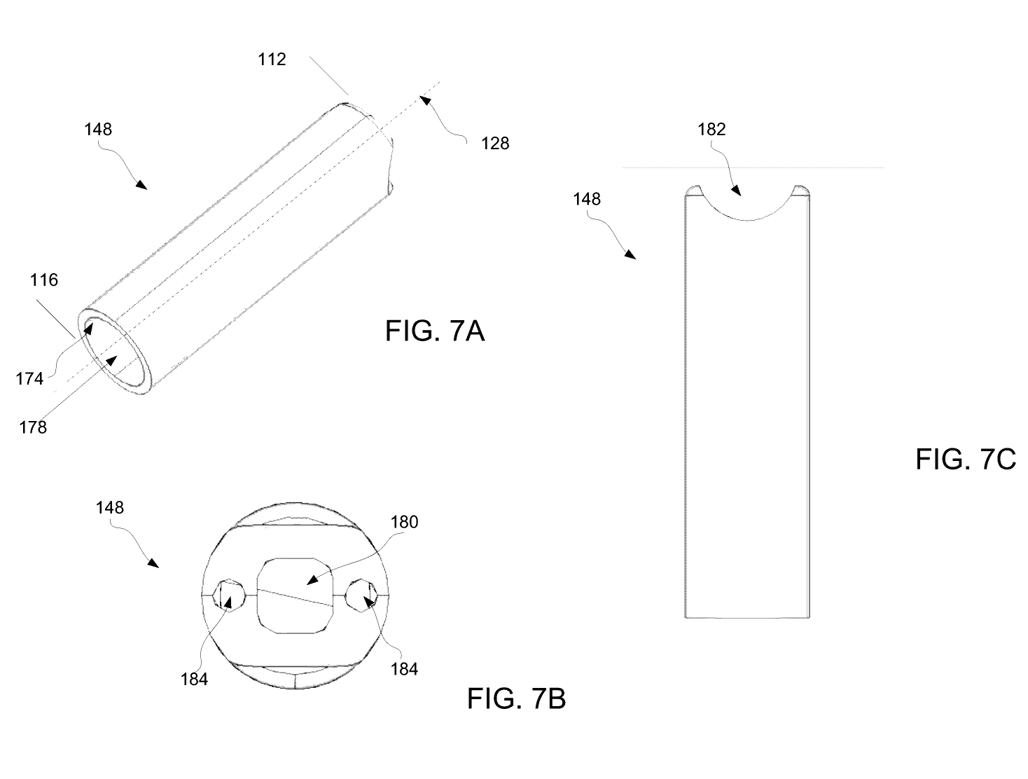

Turning next to FIGS. 7A, 7B, and 7C, the sleeve 148 is depicted according to various views. According to one embodiment, the sleeve 148 may include a substantially tubular shape for disposition over the tube outer surface 149 (e.g., for surrounding overlapping disposition of the sleeve 148 onto the tube 140). In this regard, the sleeve 148 may include a sleeve inner surface 174 and a sleeve outer surface 176 defining a sleeve cylindrical opening 178 spanning the length of the sleeve 148. Notably, however, the sleeve 148 is presented as a tubular shape for purposes of illustration only. The sleeve 148 may be of any appropriate construction for disposition onto the tube 140 such that the sleeve 148 is displaceable relative to the tube 140 with respect to the bearing surface interface 150 (i.e. such that the sleeve may be disposed in adjacent overlapping relation with the tube 140 at the driver distal end 112 to define a bearing surface interface 150 between the sleeve inner surface 174 and the tube outer surface 149).

The sleeve 148 may also include at driver distal end 112 an aperture 180 concentric with axis 128 for facilitating the fixed attachment of the torsion member 136 to the sleeve 148 at the driver distal end 112. For example, the aperture 148 may receive the torsion member 136 at the driver distal end for fixed attachment of the torsion member 136 to the sleeve 148 (e.g., via an interface fit, welded attachment, screwed attachment and/or the like). The sleeve 148 may be disposed in substantially surrounding relation to the torsion member 136 such that the torsion member 136 extends substantially the length of the sleeve 148 for receipt by the aperture 180. In this regard, the sleeve 148 may be disposed in adjacent surrounding relation to the tube 140 such that the sleeve is displaceable with respect to the tube 140 while fixed with respect to the torsion member 136. Accordingly, the elastic deformation of the torsion member 136 (as defined by angle of twist θ) may cause the sleeve 148 to displace relative to the tube 140 (i.e., due at least in part to the fixed attachment of the sleeve 148 with the torsion member 136). In this regard, the displacement of the sleeve 148 relative to the tube 140 may be indicative of a torque applied by the torque indicating drive 104 (e.g., by reference to indicator 146, discussed above).

The sleeve 148 may also include at driver distal end 112 a seat 182 for facilitating the fixed attachment of the sleeve 148 to the handle member 120 at the driver distal end 112. The seat 182 may be configured for receiving handle member 120 (e.g., via an arcuate portion) such that displacement (e.g., rotational displacement) of the handle member 120 may cause displacement of the sleeve 148. In this regard, both the handle member 120 and the torsion member 136 may be rotationally constrained with respect to the sleeve 148 at the driver distal end 112. Accordingly, displacement of the handle may cause the sleeve 148 to be displaced relative to the tube 140 as a function of the elastic deformation of the torsion member 136. In some embodiments, the seat 182 may include one or more attachment elements 184 (e.g., screw fittings, welds, or the like) at the driver distal end 112 to facilitate the fixed attachment of the handle member 120 to the sleeve 148.

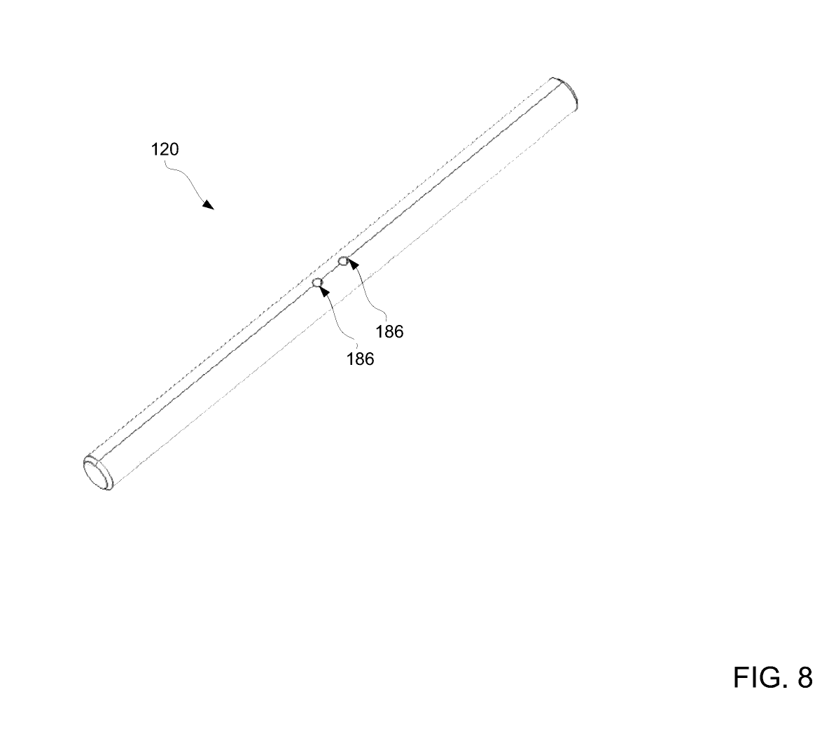

Turning next to FIG. 8, an isometric view of the handle member 120 is depicted. According to one embodiment, handle member 120 may include a substantially tubular shape for disposition onto to the sleeve 148 (e.g., via the fixed attachment of the handle member 120 to sleeve 148). In this regard, the handle member 120 may include one or more corresponding attachment elements 186 associated with the one or more attachment elements 184. That is, the one or more attachment elements 184 and the one or more corresponding attachment elements 186 may be associated to facilitate the fixed attachment of the handle member 120 to the sleeve 148 (e.g., via screws 152).

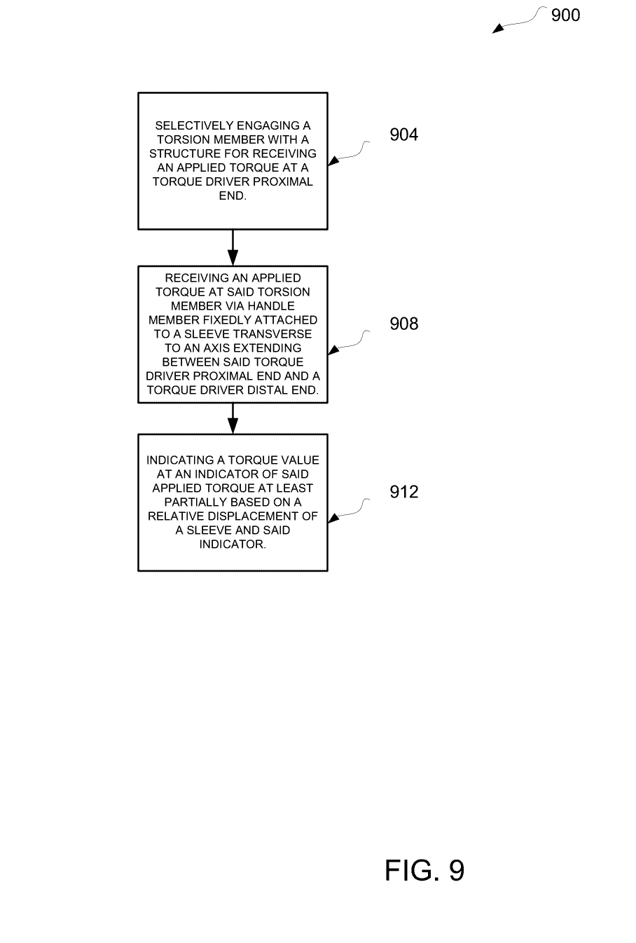

To facilitate the reader's understanding of the various functionalities of the utilities discussed herein, reference is now made to the flow diagram in FIG. 9, which illustrates a method 900, for use in indicating a value of an applied torque. While specific steps (and orders of steps) of the method 900 will be illustrated and discussed, other methods (including more, fewer, or different steps than those illustrated) consistent with the teachings presented herein are also envisioned and encompassed with the present disclosure.

With reference to FIG. 9, method 900 relates generally to indicating a value of an applied torque (e.g., via torque indicating driver 104). In this regard, the method may include selectively engaging 904 a torsion member (e.g., torsion member 136) with a structure for receiving an applied torque (e.g., receiving structure 108) at a driver proximal end. The torsion member may include a circular cross-section elastically deformable about an axis (e.g., axis 128) extending between the torque driver proximal end and a torque driver distal end. The torsion member may be fixedly attached to a tube (e.g., tube 140) at the torque driver proximal end such that the tube is disposed in surrounding relation to the torsion member concentric with the axis to define an annular space (e.g., annular space 138) between at least a portion of the torsion member and an inner surface of the tube between the torque driver proximal end and the torque driver distal end.

The method may continue by receiving 908 an applied torque at the torsion member via a handle member (e.g., handle member 120) fixedly attached to a sleeve (e.g., sleeve 148) transverse to the axis such that the sleeve is displaced relative to an indicator (e.g., indicator 146) disposed on an outer surface of the tube at the torque driver distal end. In this regard, the relative displacement of the sleeve and the indicator is indicative of the applied torque relative to the corresponding elastic deformation of the torsion member by the applied torque. Furthermore, the sleeve is disposed in adjacent overlapping relation with the tube at the torque driver distal end. The sleeve may include an inner surface directly engaged with an outer surface of the tube to define a bearing surface interface (e.g., interface 150) between the inner surface of the sleeve and the outer surface of the tube.

The method may continue by indicating 912 a torque value at the indicator of the applied torque at least partially based on the relative displacement of the sleeve and the indicator.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A torque indicating driver, comprising:
a torsion member with a circular cross section elastically deformable about an axis extending between a driver proximal end and a driver distal end;
a tube disposed in surrounding relation to said torsion member and concentric with said axis to define an annular space between at least a portion of said torsion member and an inner surface of said tube between said driver proximal end and said driver distal end, wherein said torsion member is fixedly attached to said tube at said diver proximal end;
an indicator disposed on an outer surface of said tube at said driver distal end;
a sleeve disposed in adjacent overlapping relation with said tube at said driver distal end, wherein said torsion member is fixedly attached to said sleeve at said driver distal end, and wherein said sleeve comprises an inner surface directly engaged with said outer surface of said tube to define a bearing surface interface between said inner surface of said sleeve and said outer surface of said tube such that said sleeve is displaceable relative to said indicator, and wherein said relative displacement of said sleeve and said indicator is indicative of an applied torque relative to said corresponding elastic deformation of said torsion member by said applied torque; and
a handle member fixedly attached to said sleeve transverse to said axis to receive said applied torque, wherein said handle member is operable to displace said sleeve such that said torsion member elastically deforms about said axis.

2. The torque indicating driver of claim 1, wherein said torsion member comprises an engagement member fixedly attached to said torsion member at said driver proximal end.

3. The torque indicating driver of claim 2, wherein said torsion member is fixedly attached to said tube at said driver proximal end at said engagement member.

4. The torque indicating driver of claim 1, wherein a pin transverse to said axis fixedly attaches said torsion member to said tube.

5. The torque indicating driver of claim 2, wherein said engagement member comprises a projection portion for selective removable engagement with a structure for receiving said applied torque.

6. The torque indicating driver of claim 5, wherein said projection portion comprises at least one attachment piece for said selective removable engagement of said projection portion with said structure for receiving said applied torque.

7. The torque indicating driver of claim 1, wherein said torsion member has length of at least 9.2 inches.

8. The torque indicating driver of claim 1, wherein said circular cross section of said torsion member has a cross-dimensional area of at least 0.038 square inches.

9. The torque indicating driver of claim 1, wherein said torsion member has a modulus of rigidity of at least 11.0×10³ kilo pounds per square inch.

10. The torque indicating driver of claim 1, wherein said indicator comprises a raised shell disposed in surrounding relation to said tube.

11. The torque indicating driver of claim 10, wherein said sleeve is disposed in adjacent contactable relation with said raised shell.

12. The torque indicating driver of claim 1, wherein said indicator comprises an incremental scale with a first plurality of increments, said first plurality of increments corresponding to a value indicative of said applied torque.

13. The torque indicating driver of claim 12, wherein said incremental scale comprises a second plurality of increments, said second plurality of increments corresponding to a value indicative of said applied torque and disposed at said indicator 120 degrees from said first plurality of increments.

14. The torque indicating driver of claim 12, wherein said relative displacement of said sleeve and said indicator corresponds to said plurality of increments such that each increment of said plurality of increments indicates said applied torque relative to said corresponding elastic deformation of said torsion member by said applied torque.

15. The torque indicating driver of claim 14, wherein said incremental scale has a range from 4 to 20 foot-pounds.

16. The torque indicating driver of claim 1, wherein said sleeve comprises an aperture concentric with said axis for receiving said torsion member for said fixed attachment of said torsion member at said driver distal end.

17. The torque indicating driver of claim 1, wherein said sleeve comprises an arcuate portion for receiving said handle member.

18. The torque indicating driver of claim 17, wherein said handle member is fixedly attached to said sleeve at said arcuate portion via at least one attachment element.

19. A method for indicating a value of an applied torque, the method comprising:
selectively engaging a torsion member with a structure for receiving an applied torque at a torque driver proximal end, wherein said torsion member comprises a circular cross section elastically deformable about an axis extending between said torque driver proximal end and a torque driver distal end, and wherein said torsion member is fixedly attached to a tube at said torque driver proximal end, and wherein said tube is disposed in surrounding relation to said torsion member concentric with said axis to define an annular space between at least a portion of said torsion member and an inner surface of said tube between said torque driver proximal end and said torque driver distal end;
receiving an applied torque at said torsion member via a handle member fixedly attached to a sleeve transverse to said axis such that said sleeve is displaced relative to an indicator disposed on an outer surface of said tube at said torque driver distal end, wherein said relative displacement of said sleeve and said indicator is indicative of said applied torque relative to said corresponding elastic deformation of said torsion member by said applied torque, and wherein said sleeve is disposed in adjacent overlapping relation with said tube at said torque driver distal end, wherein said sleeve comprises an inner surface directly engaged with an outer surface of said tube to define a bearing surface interface between said inner surface of said sleeve and said outer surface of said tube; and
indicating a torque value at said indicator of said applied torque at least partially based on said relative displacement of said sleeve and said indicator.

20. The method of claim 19, wherein said indicator comprises an incremental scale with a plurality of increments such that each increment of said plurality of increments corresponds to said torque value of said applied torque.

21. The method of claim 20, wherein said relative displacement of said sleeve and said indicator corresponds to said plurality of increments such that each increment of said plurality of increments indicates said applied torque relative to said corresponding elastic deformation of said torsion member by said applied torque.

22. The method of claim 21, wherein said incremental scale has a range from 4 to 20 foot-pounds.
